(19) United States
(12) Patent Application Publication
(10) Pub. No.: US 2023/0141338 A1
(43) Pub. Date: May 11, 2023

(54) METHODS, UE AND BASE STATION OF COMMUNICATION

(71) Applicant: OROPE FRANCE SARL, Neuilly-sur-Seine (FR)

(72) Inventor: Hao LIN, Neuilly-sur-Seine (FR)

(73) Assignee: OROPE FRANCE SARL, Neuilly-sur-Seine (FR)

(21) Appl. No.: 18/148,364

(22) Filed: Dec. 29, 2022

Related U.S. Application Data
(63) Continuation of application No. PCT/IB2020/000802, filed on Jul. 10, 2020.

(51) Int. Cl. H04L 1/1829; H04W 72/232

(52) U.S. Cl. CPC H04L 1/1864; H04W 72/232; H04L 1/1854

(57) ABSTRACT

An apparatus and a method of communication are provided. The method of communication of a user equipment (UE) includes receiving a first downlink control information (DCI) from a base station, the first DCI being used to schedule a first physical downlink shared channel (PDSCH) corresponding to a hybrid automatic repeat request (HARQ) process number; and receiving a second PDSCH from the base station before transmitting a HARQ-ACK information of the first PDSCH and after receiving the first PDSCH or after the first DCI. The second PDSCH is scheduled by a second DCI and the second PDSCH is corresponding to the HARQ process number.

### CROSS-REFERENCE TO RELATED APPLICATION

This is a continuation of International Patent Application No. PCT/IB2020/000802, filed on Jul. 10, 2020, the disclosure of which is hereby incorporated by reference in its entirety.

### BACKGROUND

Non-terrestrial networks (NTNs) refer to networks, or segments of networks, using a spaceborne vehicle or an airborne vehicle for transmission. Spaceborne vehicles include satellites including low earth orbiting (LEO) satellites, medium earth orbiting (MEO) satellites, geostationary earth orbiting (GEO) satellites, and highly elliptical orbiting (HEO) satellites. Airborne vehicles include high altitude platforms (HAPs) encompassing unmanned aircraft systems (UAS) including lighter than air (LTA) unmanned aerial systems (UAS) and heavier than air (HTA) UAS, all operating in altitudes typically between 8 and 50 km, quasi-stationary.

Communication via a satellite is an interesting means thanks to its well-known coverage, which can bring the coverage to locations that normally cellular operators are not willing to deploy either due to non-stable crowd potential client, e.g. extreme rural, or due to high deployment cost, e.g. middle of ocean or mountain peak. Nowadays, the satellite communication is a separate technology to a 3rd generation partnership project (3GPP) cellular technology. Coming to 5G era, these two technologies can merge together, i.e. we can imagine having a 5G terminal that can access to a cellular network and a satellite network. The NTN can be good candidate technology for this purpose. It is to be designed based on 3GPP new radio (NR) with necessary enhancement.

In NTN system, due to the very long round trip time between the satellite and the user equipment, the transmission throughput is limited. The UE needs to wait long time to report the hybrid automatic repeat request acknowledgement (HARQ-ACK) information of a received physical downlink shared channel (PDSCH) in a physical uplink control channel (PUCCH) transmission. In the prior art, before the UE reporting the HARQ-ACK information of a PDSCH, the corresponding HARQ process number is blocked from being reused for another PDSCH transmission. Given that the number of the HARQ process number is limited and in general a few, the base station has to wait until the UE completes the PUCCH transmission then be able to reuse the same HARQ process number. The PUCCH transmission needs to cover the very long round trip time, leading to a risk that one or more HARQ process numbers might be blocked for a long period of time during the NTN communications.

Therefore, there is a need for an apparatus (such as a user equipment (UE) and/or a base station) and a method of communication, which can solve issues in the prior art, increase a transmission throughput that can resolve a bottleneck due to a long round trip time, and/or provide a good communication performance and high reliability.

### SUMMARY

The present disclosure relates to the field of communication systems, and more particularly, to an apparatus (such as a user equipment (UE) and/or a base station) and a method of communication in a non-terrestrial network (NTN), which can provide a good communication performance and high reliability, can solve issues in the prior art, and can increase a transmission throughput that can resolve a bottleneck due to a long round trip time.

In a first aspect of the present disclosure, a method of communication of a user equipment comprises receiving a first downlink control information (DCI) from a base station, wherein the first DCI is used to schedule a first physical downlink shared channel (PDSCH) corresponding to a hybrid automatic repeat request (HARQ) process number; and receiving a second PDSCH from the base station before transmitting a HARQ-ACK information of the first PDSCH and after receiving the first PDSCH or after the first DCI, wherein the second PDSCH is scheduled by a second DCI and the second PDSCH is corresponding to the HARQ process number.

In a second aspect of the present disclosure, a user equipment of communication comprises a memory, a transceiver, and a processor coupled to the memory and the transceiver. The transceiver is configured to receive a first downlink control information (DCI) from a base station, wherein the first DCI is used to schedule a first physical downlink shared channel (PDSCH) corresponding to a hybrid automatic repeat request (HARQ) process number. The transceiver is configured to receive a second PDSCH from the base station before transmitting a HARQ-ACK information of the first PDSCH and after receiving the first PDSCH or after the first DCI, wherein the second PDSCH is scheduled by a second DCI and the second PDSCH is corresponding to the HARQ process number.

In a third aspect of the present disclosure, a method of communication of a base station comprises transmitting a first downlink control information (DCI) to a user equipment (UE), wherein the first DCI is used to schedule a first physical downlink shared channel (PDSCH) corresponding to a hybrid automatic repeat request (HARQ) process number; and transmitting a second PDSCH to the UE before the UE transmits a HARQ-ACK information of the first PDSCH and after the UE receives the first PDSCH or after the first DCI, wherein the second PDSCH is scheduled by a second DCI and the second PDSCH is corresponding to the HARQ process number.

In a fourth aspect of the present disclosure, a base station of communication comprises a memory, a transceiver, and a processor coupled to the memory and the transceiver. The transceiver is configured to transmit a first downlink control information (DCI) to a user equipment (UE), wherein the first DCI is used to schedule a first physical downlink shared channel (PDSCH) corresponding to a hybrid automatic repeat request (HARQ) process number. The transceiver is configured to transmit a second PDSCH to the UE before the UE transmits a HARQ-ACK information of the first PDSCH and after the UE receives the first PDSCH or after the first DCI, wherein the second PDSCH is scheduled by a second DCI and the second PDSCH is corresponding to the HARQ process number.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of one or more user equipments (UEs) and a base station (e.g., gNB) of communication in a communication network system (e.g., non-terrestrial network (NTN)) according to an embodiment of the present disclosure.

FIG. 2 is a flowchart illustrating a method of communication of a user equipment in a non-terrestrial network (NTN) according to an embodiment of the present disclosure.

FIG. 3 is a flowchart illustrating a method of communication of a base station in a non-terrestrial network (NTN) according to an embodiment of the present disclosure.

FIG. 4 is a schematic diagram illustrating a communication system including a base station (BS) and a UE according to an embodiment of the present disclosure.

FIG. 5 is a schematic diagram illustrating that a BS transmits 3 beams to the ground forming 3 footprints according to an embodiment of the present disclosure.

FIG. 6 is a schematic diagram illustrating a method of HARQ feedback for an NTN system according to an embodiment of the present disclosure.

FIG. 7 is a schematic diagram illustrating a method of HARQ feedback for an NTN system according to another embodiment of the present disclosure.

FIG. 8 is a schematic diagram illustrating a method of HARQ feedback for an NTN system according to another embodiment of the present disclosure.

FIG. 9 is a schematic diagram illustrating a method of HARQ feedback for an NTN system according to another embodiment of the present disclosure.

FIG. 10 is a schematic diagram illustrating a method of HARQ feedback for an NTN system according to another embodiment of the present disclosure.

FIG. 11 is a schematic diagram illustrating a method of HARQ feedback for an NTN system according to another embodiment of the present disclosure.

FIG. 12 illustrates a method of HARQ feedback for an NTN system according to another embodiment of the present disclosure.

FIG. 13 illustrates a method of HARQ feedback for an NTN system according to another embodiment of the present disclosure.

FIG. 14 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

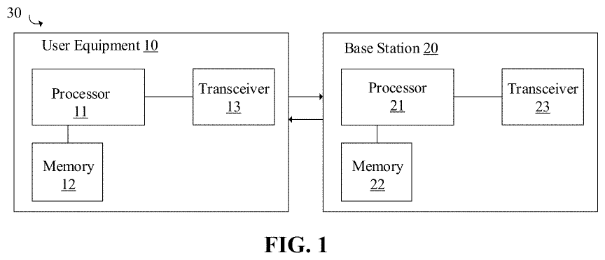

FIG. 1 illustrates that, in some embodiments, one or more user equipments (UEs) 10 and a base station (e.g., gNB) 20 for transmission adjustment in a communication network system 30 (e.g., non-terrestrial network (NTN)) according to an embodiment of the present disclosure are provided. The communication network system 30 includes the one or more UEs 10 and the base station 20. The one or more UEs 10 may include a memory 12, a transceiver 13, and a processor 11 coupled to the memory 12, the transceiver 13. The base station 20 may include a memory 22, a transceiver 23, and a processor 21 coupled to the memory 22, the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the communication between the UE 10 and the BS 20 comprises non-terrestrial network (NTN) communication. In some embodiments, the base station 20 comprises spaceborne platform or airborne platform or high altitude platform station.

In some embodiments, the transceiver 13 is configured to receive a first downlink control information (DCI) from the base station 20, wherein the first DCI is used to schedule a first physical downlink shared channel (PDSCH) corresponding to a hybrid automatic repeat request (HARQ) process number. The transceiver 13 is configured to receive a second PDSCH from the base station 20 before transmitting a HARQ-ACK information of the first PDSCH and after receiving the first PDSCH or after the first DCI, wherein the second PDSCH is scheduled by a second DCI and the second PDSCH is corresponding to the HARQ process number. This can solve issues in the prior art, increase a transmission throughput that can resolve a bottleneck due to a long round trip time, and/or provide a good communication performance and high reliability. This can also enable a HARQ disabling, which allows the base station to consecutively transmit PDSCHs that correspond to a same HARQ process number. Moreover, some methods are provided for the UE to feedback the HARQ-ACK information of the transmitted or received PDSCHs corresponding to the same HARQ process number. In some examples, the HARQ-ACK information of the first PDSCH is transmitted in a physical uplink control channel (PUCCH), and the PUCCH is transmitted in a PUCCH occasion indicated by the first DCI.

In some embodiments, the transceiver 23 is configured to transmit a first downlink control information (DCI) to the user equipment (UE) 10, wherein the first DCI is used to schedule a first physical downlink shared channel (PDSCH) corresponding to a hybrid automatic repeat request (HARQ) process number. The transceiver 23 is configured to transmit a second PDSCH to the UE before the UE 10 transmits a HARQ-ACK information of the first PDSCH and after the UE 10 receives the first PDSCH or after the first DCI, wherein the second PDSCH is scheduled by a second DCI and the second PDSCH is corresponding to the HARQ process number. This can solve issues in the prior art, increase a transmission throughput that can resolve a bottleneck due to a long round trip time, and/or provide a good communication performance and high reliability. This can also enable a HARQ disabling, which allows the base station to consecutively transmit PDSCHs that correspond to a same HARQ process number. Moreover, some methods are provided for the UE to feedback the HARQ-ACK information of the transmitted or received PDSCHs corresponding to the same HARQ process number. In some examples, the HARQ-ACK information of the first PDSCH is transmitted in a physical uplink control channel (PUCCH), and the PUCCH is transmitted in a PUCCH occasion indicated by the first DCI.

In some embodiments, the first DCI indicates a PUCCH occasion. In some embodiments, the transceiver 13 is configured to transmit the PUCCH in the PUCCH occasion. In some embodiments, the PUCCH comprises a hybrid automatic repeat request acknowledgement (HARQ-ACK) information of the first PDSCH corresponding to the HARQ process number.

In some embodiments, the first DCI indicates the processor 11 to feedback a HARQ-ACK information of the first PDSCH. In some embodiments, the second DCI indicates the processor 11 to feedback a HARQ-ACK information of the second PDSCH. In some embodiments, the first DCI indicates the processor 11 not to feedback a HARQ-ACK information of the first PDSCH. In some embodiments, the second DCI indicates the processor 11 not to feedback a HARQ-ACK information of the second PDSCH. In some embodiments, the processor 11 feedbacks a HARQ-ACK information of at least one PDSCH corresponding to the HARQ process number according to a radio resource control (RRC) configuration. In some embodiments, the processor 11 is configured not to feedback a HARQ-ACK information of at least one PDSCH corresponding to the HARQ process number according to an RRC configuration.

In some embodiments, the at least one PDSCH comprises the first PDSCH and/or the second PDSCH. In some embodiments, the RRC configuration is relevant to a HARQ disabling feature. In some embodiments, the first PDSCH carries a first transport block (TB) corresponding to the HARQ process number. In some embodiments, the second PDSCH carries a second TB corresponding to the HARQ process number. In some embodiments, the second TB is different from the first TB. In some embodiments, the second TB is same as the first TB. In some embodiments, the first DCI comprises a first indication field having a first new data indicator (NDI), and the second DCI comprises a second indication field having a second NDI. In some embodiments, via an RRC configuration, the first PDSCH is configured with a first NDI and the second PDSCH is configured with a second NDI. In some embodiments, the second NDI is different from the first NDI. In some embodiments, the second NDI is same as the first NDI.

In some embodiments, the processor 11 is configured to report a HARQ-ACK codebook (CB). In some embodiments, the HARQ-ACK CB has a semi-static size. In some embodiments, the HARQ-ACK CB comprises a type 1 HARQ-ACK CB. In some embodiments, the HARQ-ACK CB comprises one or more HARQ-ACK information corresponding to one or more PDSCH candidate locations. In some embodiments, the HARQ-ACK CB is reported in the PUCCH. In some embodiments, the one or more PDSCH candidate locations are relevant to at least one of the followings: the PUCCH occasion, one or more candidate PDSCH-to-HARQ feedback timing, or one or more timing offsets. In some embodiments, the one or more candidate PDSCH-to-HARQ feedback timing comprises at least an integer value, wherein the integer value is positive or negative.

In some embodiments, the one or more timing offsets are used for determining an uplink transmission resource. In some embodiments, the uplink transmission comprises at least one of the followings: a PUSCH, a PUCCH, or an SRS. In some embodiments, the one or more timing offsets are relevant to one or more transmission round trip time or to one or more timing advance values. In some embodiments, the one or more PDSCH candidate locations are relevant to the one or more candidate PDSCH-to-HARQ feedback timing with positive values. In some embodiments, the first DCI and/or the second DCI comprises a first DCI format and/or a second DCI format. In some embodiments, the first DCI format comprises at least one of the followings: a PDSCH-to-HARQ feedback timing indication field, a HARQ process number indication field, or an NDI indication field.

In some embodiments, the second DCI format is different from the first DCI format at least by one of the followings: the PDSCH-to-HARQ feedback timing indication field, the HARQ process number indication field, or the NDI indication field. In some embodiments, the PDSCH-to-HARQ feedback timing indication field indicates one of the candidate PDSCH-to-HARQ feedback timing. In some embodiments, the PUCCH occasion is determined by the one of the candidate PDSCH-to-HARQ feedback timing and/or one of the one or more timing offsets. In some embodiments, the first PDSCH is received in a first one of the candidate PDSCH locations. In some embodiments, the HARQ-ACK information of the first PDSCH is not included in the HARQ-ACK CB. In some embodiments, the HARQ-ACK information corresponding to the first one of the candidate PDSCH locations is a NACK. In some embodiments, the HARQ-ACK information of the first PDSCH is included in the HARQ-ACK CB.

In some embodiments, the HARQ-ACK information corresponding to the first one of the candidate PDSCH locations is the HARQ-ACK information of the first PDSCH. In some embodiments, the second PDSCH is received in a second one of the candidate PDSCH locations. In some embodiments, the HARQ-ACK information of the second PDSCH is not included in the HARQ-ACK CB. In some embodiments, the HARQ-ACK information corresponding to the second one of the candidate PDSCH locations is a NACK. In some embodiments, the HARQ-ACK information of the second PDSCH is included in the HARQ-ACK CB. In some embodiments, the HARQ-ACK information corresponding to the second one of the candidate PDSCH locations is the HARQ-ACK information of the second PDSCH. In some embodiments, the HARQ-ACK information corresponding to the first one of the candidate PDSCH locations is the HARQ-ACK information of the second PDSCH.

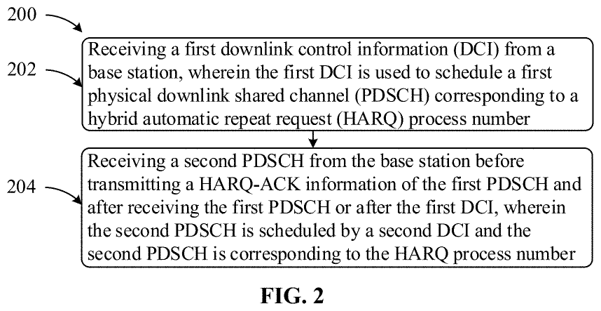

FIG. 2 illustrates a method 200 of communication of a UE in a communication network system (e.g., non-terrestrial network (NTN)) according to an embodiment of the present disclosure. In some embodiments, the method 200 includes: a block 202, receiving a first downlink control information (DCI) from a base station, wherein the first DCI is used to schedule a first physical downlink shared channel (PDSCH) corresponding to a hybrid automatic repeat request (HARQ) process number; and a block 204, receiving a second PDSCH from the base station before transmitting a HARQ-ACK information of the first PDSCH and after receiving the first PDSCH or after the first DCI, wherein the second PDSCH is scheduled by a second DCI and the second PDSCH is corresponding to the HARQ process number. In some examples, the HARQ-ACK information of the first PDSCH is transmitted in a physical uplink control channel (PUCCH), and the PUCCH is transmitted in a PUCCH occasion indicated by the first DCI. This can solve issues in the prior art, increase a transmission throughput that can resolve a bottleneck due to a long round trip time, and/or provide a good communication performance and high reliability. This can also enable a HARQ disabling, which allows the base station to consecutively transmit PDSCHs that correspond to a same HARQ process number. Moreover, some methods are provided for the UE to feedback the HARQ-ACK information of the transmitted or received PDSCHs corresponding to the same HARQ process number.

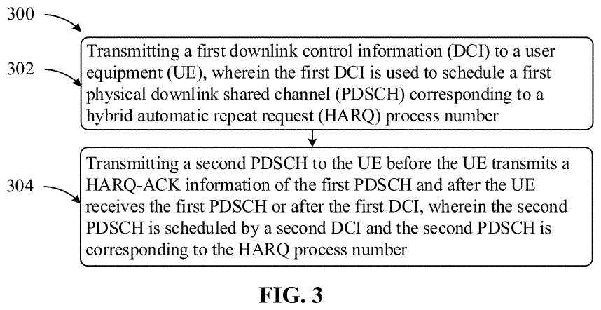

FIG. 3 illustrates a method 300 of communication of a BS in a communication network system (e.g., non-terrestrial network (NTN)) according to an embodiment of the present disclosure. In some embodiments, the method 300 includes: a block 302, transmitting a first downlink control information (DCI) to a user equipment (UE), wherein the first DCI is used to schedule a first physical downlink shared channel (PDSCH) corresponding to a hybrid automatic repeat request (HARQ) process number; and a block 304, transmitting a second PDSCH to the UE before the UE transmits a HARQ-ACK information of the first PDSCH and after the UE receives the first PDSCH or after the first DCI, wherein the second PDSCH is scheduled by a second DCI and the second PDSCH is corresponding to the HARQ process number. In some examples, the HARQ-ACK information of the first PDSCH is transmitted in a physical uplink control channel (PUCCH), and the PUCCH is transmitted in a PUCCH occasion indicated by the first DCI. This can solve issues in the prior art, increase a transmission throughput that can resolve a bottleneck due to a long round trip time, and/or provide a good communication performance and high reliability. This can also enable a HARQ disabling, which allows the base station to consecutively transmit PDSCHs that correspond to a same HARQ process number. Moreover, some methods are provided for the UE to feedback the HARQ-ACK information of the transmitted or received PDSCHs corresponding to the same HARQ process number.

In some embodiments, the first DCI indicates a PUCCH occasion. In some embodiments, the method further comprises transmitting the PUCCH in the PUCCH occasion. In some embodiments, the PUCCH comprises a hybrid automatic repeat request acknowledgement (HARQ-ACK) information of the first PDSCH corresponding to the HARQ process number. In some embodiments, the first DCI indicates the UE to feedback a HARQ-ACK information of the first PDSCH. In some embodiments, the second DCI indicates the UE to feedback a HARQ-ACK information of the second PDSCH. In some embodiments, the first DCI indicates the UE not to feedback a HARQ-ACK information of the first PDSCH. In some embodiments, the first DCI comprises a DCI format, wherein the DCI format comprises a first indication field, wherein the indication field is used to indicate the UE not to feedback a HARQ-ACK information of the first PDSCH. In some embodiments, the first indication field is PDSCH-to-HARQ_feedback timing, wherein the first indication field indicates one value from one or more candidate values, and a pre-defined value is used to indicate the UE not to feedback a HARQ-ACK information of the first PDSCH. In some embodiments, the pre-defined value is a negative integer. In some embodiments, the negative integer is −1. In some embodiments, the second DCI indicates the UE not to feedback a HARQ-ACK information of the second PDSCH. In some embodiments, the UE feedbacks a HARQ-ACK information of at least one PDSCH corresponding to the HARQ process number according to a radio resource control (RRC) configuration. In some embodiments, the UE is configured not to feedback a HARQ-ACK information of at least one PDSCH corresponding to the HARQ process number according to an RRC configuration. In some embodiments, the at least one PDSCH comprises the first PDSCH and/or the second PDSCH. In some embodiments, the RRC configuration is relevant to a HARQ disabling feature.

In some embodiments, the first PDSCH carries a first transport block (TB) corresponding to the HARQ process number. In some embodiments, the second PDSCH carries a second TB corresponding to the HARQ process number. In some embodiments, the UE expects that the second TB is different from the first TB. In some embodiments, the gNB uses RRC configuration to indicate the UE to expect that the second TB is different from the first TB. In some embodiments, the relationship between the first TB and the second TB is indicated by a second indication field in the first DCI and/or the second DCI. In some embodiments, the second indication field is new data indicator (NDI). In some embodiments, the UE expects the NDI in the first DCI and the NDI in the second DCI are same value. In some embodiments, the NDI in the first DCI and the NDI in the second DCI may be different or same value, and the UE determines the relationship between the first TB and the second TB based on the indicated NDI. In some embodiments, the first DCI and the second DCI comprise a DCI format, wherein the DCI format does not provide NDI indication, and the UE assumes the NDI of the first DCI and/or the second DCI have a pre-defined value. In some embodiments, when the first TB and the second TB are a same TB, or the NDI of the first DCI and the NDI of the second DCI have a same value, a third indication field in the second DCI indicates a pre-defined value. In some embodiments, the third indication field is used to indicate a e redundant version (RV). In some embodiment, the pre-defined value of the indicated RV is 0 or 3. In some embodiments, the UE is configured to report a HARQ-ACK codebook (CB). In some embodiments, the HARQ-ACK CB has a semi-static size. In some embodiments, the HARQ-ACK CB comprises a type 1 HARQ-ACK CB. In some embodiments, the HARQ-ACK CB comprises one or more HARQ-ACK information corresponding to one or more PDSCH candidate locations. In some embodiments, the HARQ-ACK CB is reported in the PUCCH.

In some embodiments, the one or more PDSCH candidate locations are relevant to at least one of the followings: the PUCCH occasion, one or more candidate PDSCH-to-HARQ feedback timing, or one or more timing offsets. In some embodiments, the one or more candidate PDSCH-to-HARQ feedback timing comprises at least an integer value, wherein the integer value is positive or negative. In some embodiments, the one or more timing offsets are used for determining an uplink transmission resource. In some embodiments, the uplink transmission comprises at least one of the followings: a PUSCH, a PUCCH, or a sounding reference signal (SRS). In some embodiments, the one or more timing offsets are relevant to one or more transmission round trip time or to one or more timing advance values. In some embodiments, the one or more PDSCH candidate locations are relevant to the one or more candidate PDSCH-to-HARQ feedback timing with positive values. In some embodiments, the first DCI and/or the second DCI comprises a first DCI format and/or a second DCI format. In some embodiments, the first DCI format comprises at least one of the followings: a PDSCH-to-HARQ feedback timing indication field, a HARQ process number indication field, or an NDI indication field. In some embodiments, the second DCI format is different from the first DCI format at least by one of the followings: the PDSCH-to-HARQ feedback timing indication field, the HARQ process number indication field, or the NDI indication field. In some embodiments, the PDSCH-to-HARQ feedback timing indication field indicates one of the candidate PDSCH-to-HARQ feedback timing.

In some embodiments, the PUCCH occasion is determined by the one of the candidate PDSCH-to-HARQ feedback timing and/or one of the one or more timing offsets. In some embodiments, the first PDSCH is received in a first one of the candidate PDSCH locations. In some embodiments, the HARQ-ACK information of the first PDSCH is not included in the HARQ-ACK CB. In some embodiments, the HARQ-ACK information corresponding to the first one of the candidate PDSCH locations is a negative acknowledgement (NACK). In some embodiments, the HARQ-ACK information of the first PDSCH is included in the HARQ-ACK CB. In some embodiments, the HARQ-ACK information corresponding to the first one of the candidate PDSCH locations is the HARQ-ACK information of the first PDSCH. In some embodiments, the second PDSCH is received in a second one of the candidate PDSCH locations. In some embodiments, the HARQ-ACK information of the second PDSCH is not included in the HARQ-ACK CB. In some embodiments, the HARQ-ACK information corresponding to the second one of the candidate PDSCH locations is a NACK. In some embodiments, the HARQ-ACK information of the second PDSCH is included in the HARQ-ACK CB. In some embodiments, the HARQ-ACK information corresponding to the second one of the candidate PDSCH locations is the HARQ-ACK information of the second PDSCH. In some embodiments, the HARQ-ACK information corresponding to the first one of the candidate PDSCH locations is the HARQ-ACK information of the second PDSCH.

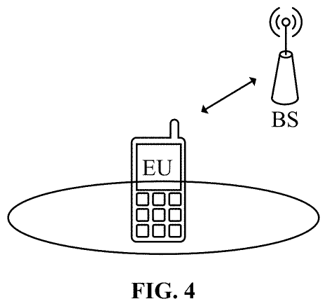

FIG. 4 illustrates a communication system including a base station (BS) and a UE according to another embodiment of the present disclosure. Optionally, the communication system may include more than one base stations, and each of the base stations may connect to one or more UEs. In this disclosure, there is no limit. As an example, the base station illustrated in FIG. 1 may be a moving base station, e.g. spaceborne vehicle (satellite) or airborne vehicle (drone). The UE can transmit transmissions to the base station and the UE can also receive the transmission from the base station. Optionally, not shown in FIG. 4, the moving base station can also serve as a relay which relays the received transmission from the UE to a ground base station or vice versa.

Spaceborne platform includes satellite and the satellite includes LEO satellite, MEO satellite and GEO satellite. While the satellite is moving, the LEO and MEO satellite is moving with regards to a given location on earth. However, for GEO satellite, the GEO satellite is relatively static with regards to a given location on earth. A spaceborne or airborne base station (BS), e.g. in particular for LEO satellite or drone, communicates with a user equipment (UE) on the ground. The round trip time (RTT) between them is time varying due to the mobility of the base station. The RTT variation is related to the distance variation between the BS and the UE. The RTT variation rate is proportional to the BS motion velocity. To ensure a good uplink synchronization, the BS will adjust the uplink transmission timing and/or frequency for the UE.

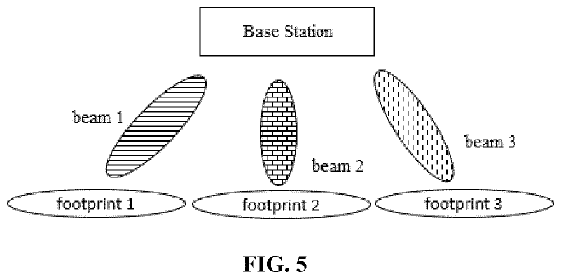

Optionally, as illustrated in FIG. 5, where a base station is integrated in a satellite or a drone, and the base station transmits one or more beams to the ground forming one or more coverage areas called footprint. In FIG. 5, an example illustrates that the BS transmits three beams (beam 1, beam 2 and beam 3) to form three footprints (footprint 1, 2 and 3), respectively. Optionally, 3 beams are transmitted at 3 different frequencies. In this example, the bit position is associated with a beam. FIG. 5 illustrates that, in some embodiments, a moving base station, e.g. in particular for LEO satellite or drone, communicates with a user equipment (UE) on the ground. Due to long distance between the UE and the base station on satellite the beamformed transmission is needed to extend the coverage. As illustrated in FIG. 5, where a base station is transmitting three beams to the earth forming three coverage areas called footpoints. Moreover, each beam may be transmitted at dedicated frequencies so that the beams for footprint 1, 2 and 3 are non-overlapped in a frequency domain.

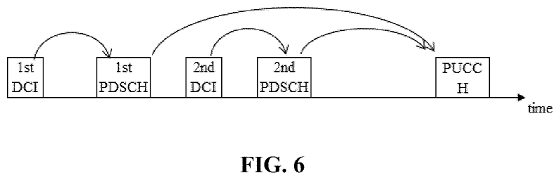

FIG. 6 illustrates a method of HARQ feedback for an NTN system according to an embodiment of the present disclosure. A UE receives a first DCI transmitted from a base station that schedules a first PDSCH, which carries a first TB corresponding to a HARQ process number. The first DCI indicates a PUCCH occasion. The UE will transmit a PUCCH in the PUCCH occasion and the PUCCH includes a HARQ-ACK information of the first TB corresponding to the HARQ process number. In another embodiment, the first DCI indicates the UE not to feedback the HARQ-ACK information. In another embodiment, the UE feedbacks or does not to feedback the HARQ-ACK information according to an RRC configuration. Before transmitting the PUCCH in the PUCCH occasion and after receiving the first PDSCH or after the first DCI, the UE may receive a second DCI from the base station that schedules a second PDSCH corresponding to the HARQ process number. This can solve issues in the prior art, increase a transmission throughput that can resolve a bottleneck due to a long round trip time, and/or provide a good communication performance and high reliability. This can also enable a HARQ disabling, which allows the base station to consecutively transmit PDSCHs that correspond to a same HARQ process number. Moreover, some methods are provided for the UE to feedback the HARQ-ACK information of the transmitted or received PDSCHs corresponding to the same HARQ process number.

In some embodiments, the second PDSCH carries a second TB, where the second TB is different from the first TB. This implies that the second PDSCH is a new transmission compared with the first PDSCH. Optionally, the second TB is same as the first TB. This implies that the second PDSCH is a re-transmission compared with the first PDSCH. The UE determines the second TB is a new transmission or a retransmission based on an indication field in the first DCI and the second DCI, where the indication field is new data indicator (NDI). In another embodiment, an RRC configuration configures whether there is NDI to determine a new transmission or a retransmission. If the NDI in the second DCI has the same value of the first DCI, it implies a retransmission, otherwise it is a new transmission. Optionally, the base station configures the HARQ process number via RRC configuration such that the second TB is always different from the first TB. When the first DCI and the second DCI contain the NDI indication field, the UE expects that the NDI value in the second DCI is different from the first DCI. Optionally, the first DCI and the second DCI do not contain NDI indication field, and the UE assumes that the NDI value of the second PSDCH is different from the NDI of the first PDSCH.

In some examples, the base station can configure the HARQ process number such that the UE receives the first DCI transmitted from the base station that schedules the first PDSCH, which carries the first TB corresponding to the HARQ process number. The first DCI indicates the PUCCH occasion. But the UE omits the HARQ-ACK information of the first TB corresponding to the HARQ process number in the PUCCH. Optionally, the first DCI does not include an indication of the PUCCH occasion. Optionally, such configuration is relevant to HARQ disabling feature.

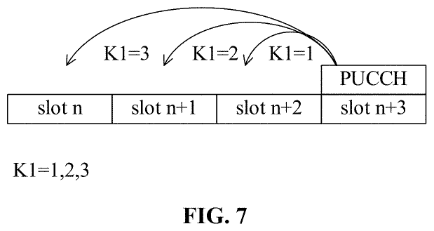

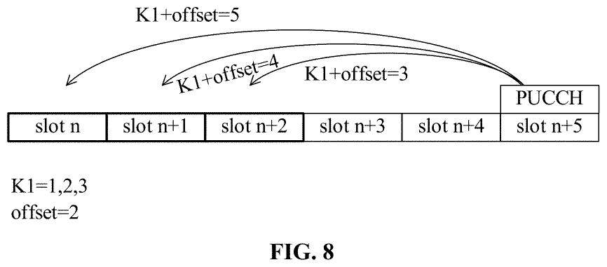

FIG. 7 illustrates a method of HARQ feedback for an NTN system according to another embodiment of the present disclosure. In some examples, the UE is configured with type 1 HARQ-ACK codebook (CB), where the HARQ-ACK CB size is semi-statically defined. The HARQ-ACK CB size is relevant to candidate PDSCH-to-HARQ_feedback timing values (K1) and/or one or more timing offset (offset) values. As illustrated in FIG. 7, where K1 is configured by the base station to have multiple candidate values and the DCI will select one value while scheduling a PDSCH via an indication field called PDSCH-to-HARQ_feedback timing indicator. In our example, the K1 is configured to have candidate values 1, 2 and 3. For a given PUCCH occasion, e.g. in slot n+3, then this will define three candidate PDSCH locations, i.e. potential scheduled PDSCHs in slot n, slot n+1 and slot n+2 and allocating PUCCH in slot n+3, leading to a size of the HARQ-ACK CB being 3. FIG. 8 illustrates a method of HARQ feedback for an NTN system according to another embodiment of the present disclosure. Optionally, as when gNB configures timing offset to be 2, the candidate PDSCH locations for a given PUCCH occasion (e.g. slot n+5) should be calculated based on both K1 and timing offset values. As illustrated in FIG. 8, the candidate PDSCH locations for the given PUCCH occasion are slot n, slot n+1, and slot n+2, leading to the HARQ-ACK CB size being 3.

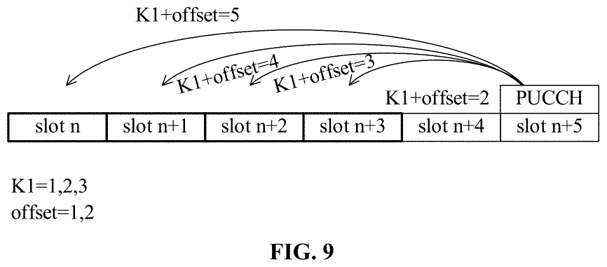

FIG. 9 illustrates a method of HARQ feedback for an NTN system according to another embodiment of the present disclosure. Optionally, when gNB configures timing offset to be more than one value, e.g. offset=1, 2, the candidate PDSCH locations for a given PUCCH occasion (e.g. slot n+5) should be calculated based on both K1 and timing offset values. As illustrated in FIG. 9, the candidate PDSCH locations for the given PUCCH occasion are slot n, slot n+1, slot n+2, and slot n+3, leading to the HARQ-ACK CB size being 4. Optionally, even gNB configures more than one timing offset, only one offset value is used to determine the HARQ-ACK CB size and the candidate PDSCH locations, where the only one offset value is selected by RRC configuration, or DCI indication, or pre-defined rule.

Optionally, when the gNB configures one or more candidate PDSCH-to-HARQ_feedback timing values, wherein there is one or more values are negative values, the negative values are not taken into account for defining candidate PDSCH locations and HARQ-ACK CB size. Optionally, when a DCI schedules a PDSCH in one of the candidate PDSCH locations, and the DCI contains a PDSCH-to-HARQ_feedback timing indicator and the indicator indicates a negative PDSCH-to-HARQ_feedback timing value, the UE does not report the HARQ-ACK information of the PDSCH in the HARQ-ACK CB.

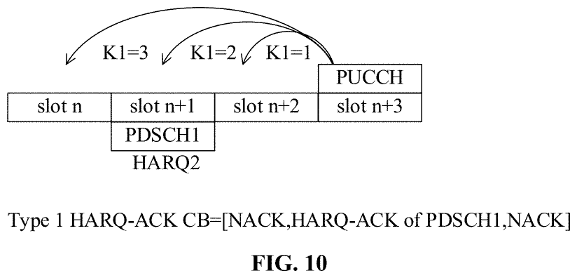

FIG. 10 illustrates a method of HARQ feedback for an NTN system according to another embodiment of the present disclosure. In some examples, for preparing the type 1 HARQ-ACK CB, the UE will also consider the HARQ process number. Following the previous examples, in case the base station further configures to activate HARQ disabling feature for HARQ process number 1 (HARQ ID=1), the UE will not only check if there is received PDSCH in the candidate PDSCH locations, e.g. slot n, n+1 and n+2, but also the UE needs to check the HARQ process number the received PDSCH corresponding to. A more specific example is that if the UE only receives PDSCH1 corresponding to HARQ ID=2 in slot n+1 and the PDSCH-to-HARQ_feedback timing indicator field in the DCI, scheduling the PDSCH1, indicates the PUCCH slot (slot 3). The UE will report NACK for slot n and slot n+2 since the UE does not receive any PDSCH in these slots. The UE will report HARQ-ACK information of the PDSCH1. It is note that similar concept is applied if timing offset is configured and the example is not repeated here.

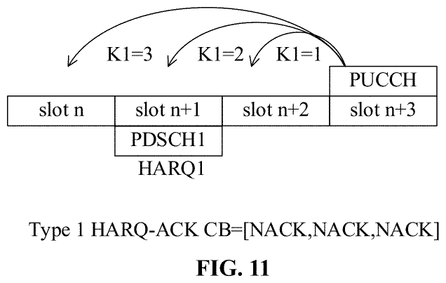

FIG. 11 illustrates a method of HARQ feedback for an NTN system according to another embodiment of the present disclosure. Alternatively, in another example as illustrated in FIG. 11, if the received PDSCH1 corresponds to HARQ ID=1 and the PDSCH-to-HARQ_feedback timing indicator field in the DCI scheduling the PDSCH1 indicates the PUCCH slot (slot 3), as the HARQ ID=1 is configured to be activated with HARQ disabling feature, the UE will not include the HARQ-ACK information of the PDSCH1 in the CB. Thus, the UE will only report NACK for the PDSCH 1 corresponding to HARQ ID=1.

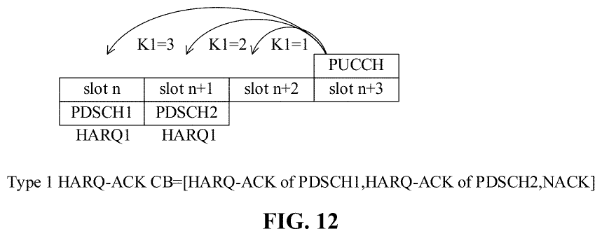

FIG. 12 illustrates a method of HARQ feedback for an NTN system according to another embodiment of the present disclosure. In some examples, as illustrated in FIG. 12, the K1 is configured to have candidate values 1, 2, and 3. The UE receives a PDSCH1 corresponding to HARQ ID=1 and the PDSCH-to-HARQ_feedback timing indicator field in the DCI scheduling the PDSCH1 indicates the PUCCH slot (slot 3), i.e. indicating K1=3. Moreover, the UE receives a PDSCH2 corresponding to HARQ ID=1 and the PDSCH-to-HARQ_feedback timing indicator field in the DCI scheduling the PDSCH2 indicates the PUCCH slot (slot 3), i.e. indicating K1=2. In this case, the UE reports the HARQ-ACK of PDSCH1 and HARQ-ACK of PDSCH2 in the PUCCH. Optionally, if the PDSCH2 is a retransmission of the PDSCH1, e.g. they carry a same TB. Then, the UE reports the HARQ-ACK of the PDSCH2 and sets the HARQ-ACK of the PDSCH1 as NACK, i.e. HARQ-ACK CB=[NACK, HARQ-ACK of PDSCH2, NACK]. Or alternatively, the UE repeats the same HARQ-ACK information of PDSCH2, i.e. the HARQ-ACK CB=[HARQ-ACK of PDSCH2, HARQ-ACK of PDSCH2, NACK]. In this example, the PDSCH1 and the PDSCH2 are scheduled by two separate DCIs. Optionally, the PDSCH1 and the PDSCH2 are scheduled by a same DCI.

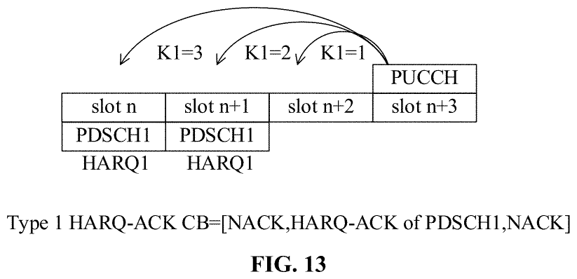

FIG. 13 illustrates a method of HARQ feedback for an NTN system according to another embodiment of the present disclosure. In some examples, as illustrated in FIG. 13, the K1 is configured to have candidate values 1, 2, and 3. The UE receives a PDSCH1 corresponding to HARQ ID=1 and the PDSCH-to-HARQ_feedback timing indicator field in the DCI scheduling the PDSCH1 indicates the PUCCH slot (slot 3), i.e. indicating K1=3. Moreover, the UE receives a PDSCH1 corresponding to HARQ ID=1 and the PDSCH-to-HARQ_feedback timing indicator field in the DCI scheduling the PDSCH2 indicates the PUCCH slot (slot 3), i.e. indicating K1=2. In this case, the second PDSCH is a retransmission of the first PDSCH1, e.g. they carry a same TB. Then, the UE reports the HARQ-ACK of the second PDSCH1 and sets the HARQ-ACK of the first PDSCH1 as NACK, i.e. HARQ-ACK CB=[NACK, HARQ-ACK of PDSCH1, NACK].

Commercial interests for some embodiments are as follows. 1. solving issues in the prior art. 2. increasing a transmission throughput that can resolve a bottleneck due to a long round trip time. 3. providing a good communication performance. 4. providing a high reliability. 5. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in the 5G NR unlicensed band communications. Some embodiments of the present disclosure propose technical mechanisms.

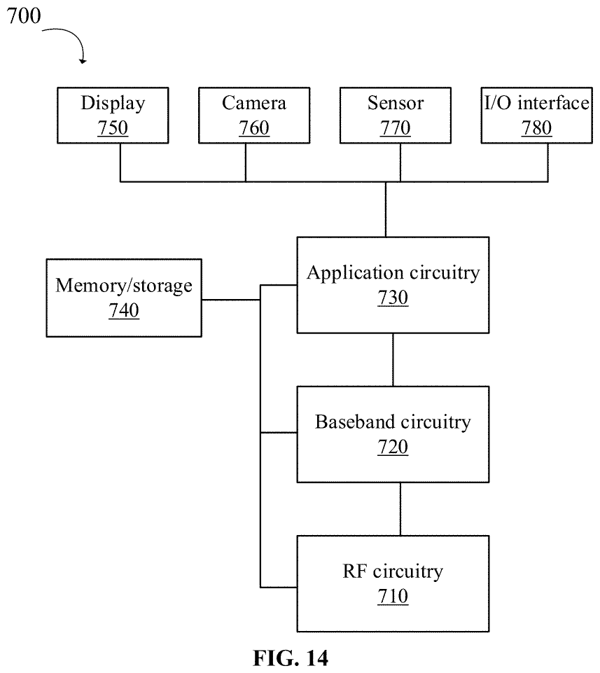

FIG. 14 is a block diagram of an example system 700 for wireless communication according to an embodiment of the present disclosure. Embodiments described herein may be implemented into the system using any suitably configured hardware and/or software. FIG. 14 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method of communication of a user equipment (UE), comprising:
receiving a first downlink control information (DCI) from a base station, wherein the first DCI is used to schedule a first physical downlink shared channel (PDSCH) corresponding to a hybrid automatic repeat request (HARQ) process number; and
receiving a second PDSCH from the base station before transmitting a hybrid automatic repeat request acknowledgement (HARQ-ACK) information of the first PDSCH and after receiving the first PDSCH or after the first DCI, wherein the second PDSCH is scheduled by a second DCI and the second PDSCH is corresponding to the HARQ process number.

2. The method of claim 1, wherein
the HARQ-ACK information of the first PDSCH is transmitted in a PUCCH transmission; or
the HARQ-ACK information of the first PDSCH is transmitted in a PUCCH transmission, and the first DCI indicates a PUCCH occasion; or
the HARQ-ACK information of the first PDSCH is transmitted in a PUCCH transmission, the first DCI indicates a PUCCH occasion, and the method further comprises transmitting the PUCCH in the PUCCH occasion; or
the PUCCH comprises the HARQ-ACK information of the first PDSCH corresponding to the HARQ process number.

3. The method of claim 1, wherein
the first PDSCH carries a first transport block (TB) corresponding to the HARQ process number, and the second PDSCH carries a second TB corresponding to the HARQ process number; or
the first PDSCH carries a first transport block (TB) corresponding to the HARQ process number, the second PDSCH carries a second TB corresponding to the HARQ process number, and the second TB is different from the first TB; or
the first PDSCH carries a first transport block (TB) corresponding to the HARQ process number, the second PDSCH carries a second TB corresponding to the HARQ process number, and the second TB is same as the first TB.

4. The method of claim 3, wherein
the first DCI comprises a first indication field having a first new data indicator (NDI), and the second DCI comprises a second indication field having a second NDI; or
via an RRC configuration, the first PDSCH is configured with a first NDI and the second PDSCH is configured with a second NDI; or
the first DCI comprises a first indication field having a first new data indicator (NDI), the second DCI comprises a second indication field having a second NDI, and the second NDI is different from the first NDI; or
via an RRC configuration, the first PDSCH is configured with a first NDI and the second PDSCH is configured with a second NDI, and the second NDI is different from the first NDI; or
the first DCI comprises a first indication field having a first new data indicator (NDI), the second DCI comprises a second indication field having a second NDI, and the second NDI is same as the first NDI; or
via an RRC configuration, the first PDSCH is configured with a first NDI and the second PDSCH is configured with a second NDI, and the second NDI is same as the first NDI.

5. The method of claim 1, wherein
the first DCI comprises a first DCI format, and the second DCI comprises a second DCI format; or
the first DCI comprises a first DCI format, and the first DCI format comprises at least one of the followings: a PDSCH-to-HARQ feedback timing indication field, a HARQ process number indication field, or an NDI indication field; or
the first DCI comprises a first DCI format, the second DCI comprises a second DCI format, and the second DCI format is different from the first DCI format at least by one of the followings: the PDSCH-to-HARQ feedback timing indication field, the HARQ process number indication field, or the NDI indication field.

6. A user equipment (UE) of communication, comprising:
a memory;
a transceiver; and
a processor coupled to the memory and the transceiver;
wherein the transceiver is configured to receive a first downlink control information (DCI) from a base station, wherein the first DCI is used to schedule a first physical downlink shared channel (PDSCH) corresponding to a hybrid automatic repeat request (HARQ) process number; and
wherein the transceiver is configured to receive a second PDSCH from the base station before transmitting a hybrid automatic repeat request acknowledgement (HARQ-ACK) information of the first PDSCH and after receiving the first PDSCH or after the first DCI, wherein the second PDSCH is scheduled by a second DCI and the second PDSCH is corresponding to the HARQ process number.

7. The UE of claim 6, wherein
the first DCI indicates the processor to feedback the HARQ-ACK information of the first PDSCH; or
the second DCI indicates the processor to feedback a HARQ-ACK information of the second PDSCH; or
the first DCI indicates the processor not to feedback the HARQ-ACK information of the first PDSCH; or
the second DCI indicates the processor not to feedback a HARQ-ACK information of the second PDSCH; or
the processor is configured to feedback a HARQ-ACK information of at least one PDSCH corresponding to the HARQ process number according to a radio resource control (RRC) configuration, and the at least one PDSCH comprises at least one of the first PDSCH or the second PDSCH; or
the processor is configured not to feedback a HARQ-ACK information of at least one PDSCH corresponding to the HARQ process number according to an RRC configuration, and the at least one PDSCH comprises at least one of the first PDSCH or the second PDSCH.

8. The UE of claim 6, wherein
the processor is configured to report a HARQ-ACK codebook (CB); or
the processor is configured to report a HARQ-ACK codebook (CB), and the HARQ-ACK CB has a semi-static size; or
the processor is configured to report a HARQ-ACK codebook (CB), and the HARQ-ACK CB comprises a type 1 HARQ-ACK CB; or
the processor is configured to report a HARQ-ACK codebook (CB), and the HARQ-ACK CB comprises one or more HARQ-ACK information corresponding to one or more PDSCH candidate locations; or
the processor is configured to report a HARQ-ACK codebook (CB), the HARQ-ACK CB comprises one or more HARQ-ACK information corresponding to one or more PDSCH candidate locations, and the one or more PDSCH candidate locations are relevant to at least one of the followings: a PUCCH occasion, one or more candidate PDSCH-to-HARQ feedback timings, or one or more timing offsets; or
the processor is configured to report a HARQ-ACK codebook (CB), the HARQ-ACK CB comprises one or more HARQ-ACK information corresponding to one or more PDSCH candidate locations, and the one or more PDSCH candidate locations are relevant to one or more candidate PDSCH-to-HARQ feedback timings with positive values.

9. The UE of claim 6, wherein
the processor is configured to report a HARQ-ACK codebook (CB), the HARQ-ACK CB comprises one or more HARQ-ACK information corresponding to one or more PDSCH candidate locations, and the first PDSCH is received in a first one of the PDSCH candidate locations; or
the processor is configured to report a HARQ-ACK codebook (CB), the HARQ-ACK CB comprises one or more HARQ-ACK information corresponding to one or more PDSCH candidate locations, and the HARQ-ACK information of the first PDSCH is not included in the HARQ-ACK CB; or
the processor is configured to report a HARQ-ACK codebook (CB), the HARQ-ACK CB comprises one or more HARQ-ACK information corresponding to one or more PDSCH candidate locations, and the HARQ-ACK information of the first PDSCH is included in the HARQ-ACK CB.

10. The UE of claim 6, wherein
the processor is configured to report a HARQ-ACK codebook (CB), the HARQ-ACK CB comprises one or more HARQ-ACK information corresponding to one or more PDSCH candidate locations, and the second PDSCH is received in a second one of the PDSCH candidate locations; or
the processor is configured to report a HARQ-ACK codebook (CB), the HARQ-ACK CB comprises one or more HARQ-ACK information corresponding to one or more PDSCH candidate locations, and a HARQ-ACK information of the second PDSCH is not included in the HARQ-ACK CB; or
the processor is configured to report a HARQ-ACK codebook (CB), the HARQ-ACK CB comprises one or more HARQ-ACK information corresponding to one or more PDSCH candidate locations, and a HARQ-ACK information of the second PDSCH is included in the HARQ-ACK CB.

11. A method of communication of a base station, comprising:
transmitting a first downlink control information (DCI) to a user equipment (UE), wherein the first DCI is used to schedule a first physical downlink shared channel (PDSCH) corresponding to a hybrid automatic repeat request (HARQ) process number; and
transmitting a second PDSCH to the UE before the UE transmits a hybrid automatic repeat request acknowledgement (HARQ-ACK) information of the first PDSCH and after receiving the first PDSCH or after the first DCI, wherein the second PDSCH is scheduled by a second DCI and the second PDSCH is corresponding to the HARQ process number.

12. The method of claim 11, wherein
the HARQ-ACK information of the first PDSCH is transmitted in a PUCCH transmission; or
the HARQ-ACK information of the first PDSCH is transmitted in a PUCCH transmission, and the first DCI indicates a PUCCH occasion; or
the HARQ-ACK information of the first PDSCH is transmitted in a PUCCH transmission, the first DCI indicates a PUCCH occasion, and the UE transmits the PUCCH in the PUCCH occasion; or
the PUCCH comprises the HARQ-ACK information of the first PDSCH corresponding to the HARQ process number.

13. The method of claim 11, wherein
the first PDSCH carries a first transport block (TB) corresponding to the HARQ process number, and the second PDSCH carries a second TB corresponding to the HARQ process number; or
the first PDSCH carries a first transport block (TB) corresponding to the HARQ process number, the second PDSCH carries a second TB corresponding to the HARQ process number, and the second TB is different from the first TB; or
the first PDSCH carries a first transport block (TB) corresponding to the HARQ process number, the second PDSCH carries a second TB corresponding to the HARQ process number, and the second TB is same as the first TB.

14. The method of claim 13, wherein
the first DCI comprises a first indication field having a first new data indicator (NDI), and the second DCI comprises a second indication field having a second NDI; or
via an RRC configuration, the first PDSCH is configured with a first NDI and the second PDSCH is configured with a second NDI; or
the first DCI comprises a first indication field having a first new data indicator (NDI), the second DCI comprises a second indication field having a second NDI, and the second NDI is different from the first NDI; or
via an RRC configuration, the first PDSCH is configured with a first NDI and the second PDSCH is configured with a second NDI, and the second NDI is different from the first NDI; or
the first DCI comprises a first indication field having a first new data indicator (NDI), the second DCI comprises a second indication field having a second NDI, and the second NDI is same as the first NDI; or
via an RRC configuration, the first PDSCH is configured with a first NDI and the second PDSCH is configured with a second NDI, and the second NDI is same as the first NDI.

15. The method of claim 11, wherein
the first DCI comprises a first DCI format, and the second DCI comprises a second DCI format; or
the first DCI comprises a first DCI format, and the first DCI format comprises at least one of the followings: a PDSCH-to-HARQ feedback timing indication field, a HARQ process number indication field, or an NDI indication field; or
the first DCI comprises a first DCI format, the second DCI comprises a second DCI format, and the second DCI format is different from the first DCI format at least by one of the followings: the PDSCH-to-HARQ feedback timing indication field, the HARQ process number indication field, or the NDI indication field.

16. A base station of communication, comprising:
a memory;
a transceiver; and
a processor coupled to the memory and the transceiver;
wherein the transceiver is configured to transmit a first downlink control information (DCI) to a user equipment (UE), wherein the first DCI is used to schedule a first physical downlink shared channel (PDSCH) corresponding to a hybrid automatic repeat request (HARQ) process number; and
wherein the transceiver is configured to transmit a second PDSCH to the UE before the UE transmits a hybrid automatic repeat request acknowledgement (HARQ-ACK) information of the first PDSCH and after receiving the first PDSCH or after the first DCI, wherein the second PDSCH is scheduled by a second DCI and the second PDSCH is corresponding to the HARQ process number.

17. The base station of claim 16, wherein
the first DCI indicates the UE to feedback the HARQ-ACK information of the first PDSCH; or
the second DCI indicates the UE to feedback a HARQ-ACK information of the second PDSCH; or
the first DCI indicates the UE not to feedback the HARQ-ACK information of the first PDSCH; or
the second DCI indicates the UE not to feedback a HARQ-ACK information of the second PDSCH; or
the UE is configured to feedback a HARQ-ACK information of at least one PDSCH corresponding to the HARQ process number according to a radio resource control (RRC) configuration, and the at least one PDSCH comprises at least one of the first PDSCH or the second PDSCH; or
the UE is configured not to feedback a HARQ-ACK information of at least one PDSCH corresponding to the HARQ process number according to an RRC configuration, and the at least one PDSCH comprises at least one of the first PDSCH or the second PDSCH.

18. The base station of claim 16, wherein
the UE is configured to report a HARQ-ACK codebook (CB); or
the UE is configured to report a HARQ-ACK codebook (CB), and the HARQ-ACK CB has a semi-static size; or
the UE is configured to report a HARQ-ACK codebook (CB), and the HARQ-ACK CB comprises a type 1 HARQ-ACK CB; or
the UE is configured to report a HARQ-ACK codebook (CB), and the HARQ-ACK CB comprises one or more HARQ-ACK information corresponding to one or more PDSCH candidate locations; or
the UE is configured to report a HARQ-ACK codebook (CB), the HARQ-ACK CB comprises one or more HARQ-ACK information corresponding to one or more PDSCH candidate locations, and the one or more PDSCH candidate locations are relevant to at least one of the followings: a PUCCH occasion, one or more candidate PDSCH-to-HARQ feedback timing, or one or more timing offsets; or
the UE is configured to report a HARQ-ACK codebook (CB), the HARQ-ACK CB comprises one or more HARQ-ACK information corresponding to one or more PDSCH candidate locations, and the one or more PDSCH candidate locations are relevant to one or more candidate PDSCH-to-HARQ feedback timing with positive values.

19. The base station of claim 16, wherein
the UE is configured to report a HARQ-ACK codebook (CB), the HARQ-ACK CB comprises one or more HARQ-ACK information corresponding to one or more PDSCH candidate locations, and the first PDSCH is received in a first one of the PDSCH candidate locations; or
the UE is configured to report a HARQ-ACK codebook (CB), the HARQ-ACK CB comprises one or more HARQ-ACK information corresponding to one or more PDSCH candidate locations, and the HARQ-ACK information of the first PDSCH is not included in the HARQ-ACK CB; or
the UE is configured to report a HARQ-ACK codebook (CB), the HARQ-ACK CB comprises one or more HARQ-ACK information corresponding to one or more PDSCH candidate locations, and the HARQ-ACK information of the first PDSCH is included in the HARQ-ACK CB.

20. The base station of claim 16, wherein
the UE is configured to report a HARQ-ACK codebook (CB), the HARQ-ACK CB comprises one or more HARQ-ACK information corresponding to one or more PDSCH candidate locations, and the second PDSCH is received in a second one of the PDSCH candidate locations; or
the UE is configured to report a HARQ-ACK codebook (CB), the HARQ-ACK CB comprises one or more HARQ-ACK information corresponding to one or more PDSCH candidate locations, and a HARQ-ACK information of the second PDSCH is not included in the HARQ-ACK CB; or
the UE is configured to report a HARQ-ACK codebook (CB), the HARQ-ACK CB comprises one or more HARQ-ACK information corresponding to one or more PDSCH candidate locations, and a HARQ-ACK information of the second PDSCH is included in the HARQ-ACK CB.
